(19) United States
(12) Patent Application Publication
(10) Pub. No.: US 2015/0161837 A1
(43) Pub. Date: Jun. 11, 2015

(54) METHODS AND SYSTEMS FOR PROVIDING CONTROL OF A DEVICE USING A FINGERPRINT SENSOR

(71) Applicants: John Stephen Smith, San Jose, CA (US); Frank Yantis Lowe, El Cerrito, CA (US)

(72) Inventors: John Stephen Smith, San Jose, CA (US); Frank Yantis Lowe, El Cerrito, CA (US)

(21) Appl. No.: 14/099,970

(22) Filed: Dec. 8, 2013

(51) Int. Cl. G07C 9/00

(52) U.S. Cl. CPC G07C 9/00158

(57) ABSTRACT

Methods and apparatuses for operating a portable device based on a fingerprint sensor are described. According to one embodiment of the invention, a fingerprint sensor attached to a portable device detects fingerprint from a particular finger at a particular orientation. In response, a machine executable code is executed within the portable device to perform one or more predetermined user configurable operations. Other methods and apparatuses are also described.

### FIELD OF THE INVENTION

The present invention relates to methods and systems for providing user control of a device using a fingerprint sensor.

### BACKGROUND

### Prior Art

The following is a tabulation of prior art that presently appears relevant:

| Patent Number | Kind code | Issue Date | Patentee |
|---|---|---|---|
| 8,144,941 | B2 | March, 2012 | Adams, et al. |
| 8,126,806 | B1 | February, 2012 | DiMartino, et al. |
| 7,946,483 | B2 | May, 2011 | Miller, et al. |
| 7,884,274 | B1 | February, 2011 | Wieder |
| 7,780,091 | B2 | August, 2010 | Beenau, et al. |
| 7,647,638 | B2 | January, 2010 | Furuyama |
| 7,602,303 | B2 | October, 2009 | Douglas, et al. |
| 7,460,109 | B2 | December, 2008 | Safai, et al. |
| 6,850,252 | B1 | February, 2005 | Hoffberg |
| 6,554,705 | B1 | April, 2003 | Cumbers |
| 6,539,101 | B1 | March, 2003 | Black |
| 6,434,403 | B1 | August, 2002 | Ausems et al. |
| 6,193,153 | B1 | February, 2001 | Lambert |
| 5,229,764 | | July, 1993 | Matchett et al. |

Mobile devices such as cell phones are used for many purposes. In addition to placing phone calls, devices may be used to browse the web, check email, send text messages, take photographs, etc. It may be desirable to authenticate a user before allowing the use of some of the functions of the phone. In some devices such authentication may be accomplished by means of a fingerprint sensor. A fingerprint sensor may be based on an optical sensor or a capacitive sensor technology. Many companies are making different types of fingerprint sensor devices suitable for use on a portable device.

Emergency calls may be made from cell phones by dialing 911 in the US, even if a cell phone is not authorized to function otherwise. Emergency bracelets or dongles are also available. Simple, fast methods of calling for emergency assistance are limited by the potential for false or accidental triggering.

User interfaces of mobile devices often provide numerous commands or user interface modes for a user to choose from. For instance, many cell phones include a camera mode. Such modes often include lists of commands or actions. There are standard modes such as a home page mode in which applications may be started or information can be displayed, etc. Machine code running on the device may be activated to send location information, acquire data from a sensor, display information, take a picture, etc.

Applications may allow recording of sound or video. The start of a recording may be accomplished by a user selecting an item from a menu, or pushing a button, or touching an area on a touch screen.

Fingerprint sensors are sometimes provided on mobile devices to authenticate authorized users of the device. Methods of authenticating users are described, for example, in U.S. Pat. No. 7,420,546 which is incorporated herein by reference.

Accelerometers may be used to select mode, for example, an accelerometer attached to a portable device detects a movement of the portable device. In response, a machine executable code is executed within the portable device to perform one or more predetermined user configurable operations as described in U.S. Pat. No. 7,688,306, incorporated herein by reference.

As such, a need exists for ways for a user to select modes of a portable device or trigger actions easily and quickly.

### SUMMARY OF THE INVENTION

One embodiment of this invention uses a fingerprint sensor attached to a portable device to trigger modes of operation as well as authenticating a user. When a user of a portable device uses a particular finger, potentially at a particular orientation, it generates a software trigger which can configure the portable device go one of several possible operating modes. For example, the user may configure the device to configure itself with a camera application if it is unlocked with the thumb of the right hand 402 of that person. The user may configure the device to come up in a different mode if it is unlocked with the index finger of that person. Another embodiment of the invention transmits an emergency signal when a fingerprint sensor is triggered by a specific finger, at a specified angle, to avoid accidental triggering of emergency response. The emergency includes the location of the device and ambient audio.

Other features and advantages of the present invention are described in greater detail below.

### BRIEF DESCRIPTION OF THE DRAWINGS

The present invention is illustrated by way of example, and not limitation, in the figures of the accompanying drawings, in which:

FIG. 1 illustrates an example of a device within which embodiments of the present invention are used, front view;

FIG. 2 illustrates an example of a portable device within which embodiments of the present invention are used, rear view;

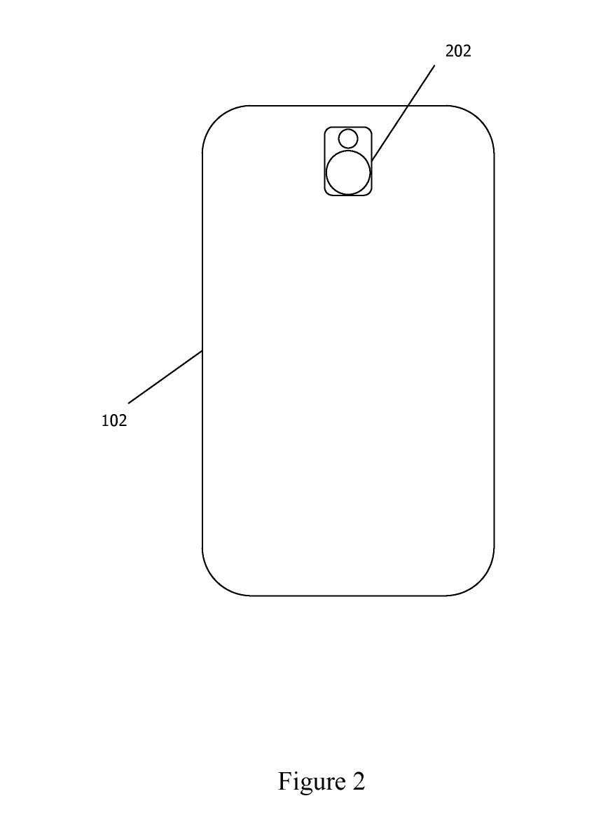

FIG. 3 illustrates a touch from an index finger in accordance with an embodiment of the present invention.

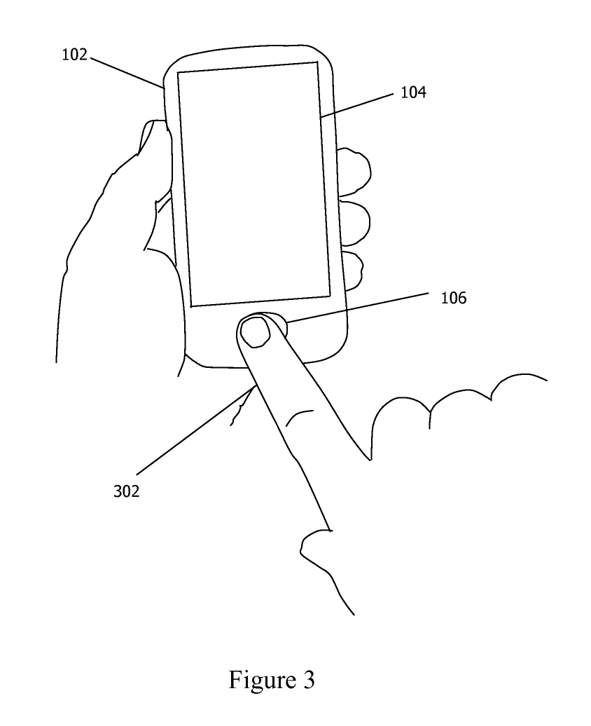

FIG. 4 illustrates a touch from a thumb in accordance with an embodiment of the present invention.

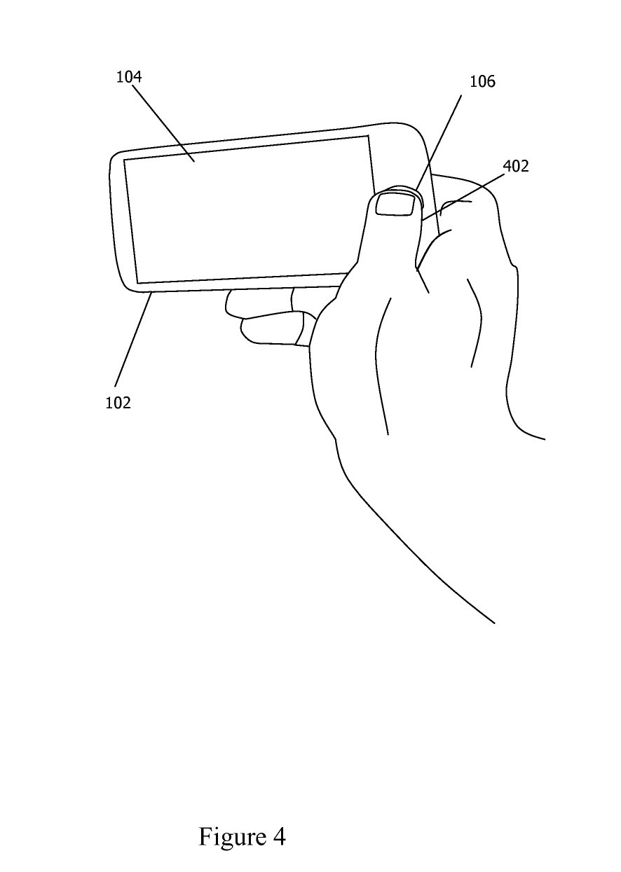

FIG. 5 illustrates an example of a block diagram of a device or system in accordance with an embodiment of the present invention;

FIG. 6 illustrates an example of a flow chart for configuring a desired action in accordance with an embodiment of the present invention;

FIG. 7 illustrates an example of a flow chart of actions triggered by fingerprint detections in accordance with an embodiment of the present invention;

### DRAWINGS

### Reference Numerals

102 Housing
104 Display with optional touch screen
106 Fingerprint sensor (optionally a portion of the display touchscreen)
108 Microphone
110 Speaker
202 Camera
302 User's right index finger touching fingerprint sensor
402 User's right thumb touching fingerprint sensor
502 Fingerprint Sensor
504 Camera module
506 Display module
508 Processor module
510 Microphone module
512 Speaker module
514 Memory
516 Security module
518 Global positioning system module

### DESCRIPTION

The present invention addresses the need for improved user interface control of a device.

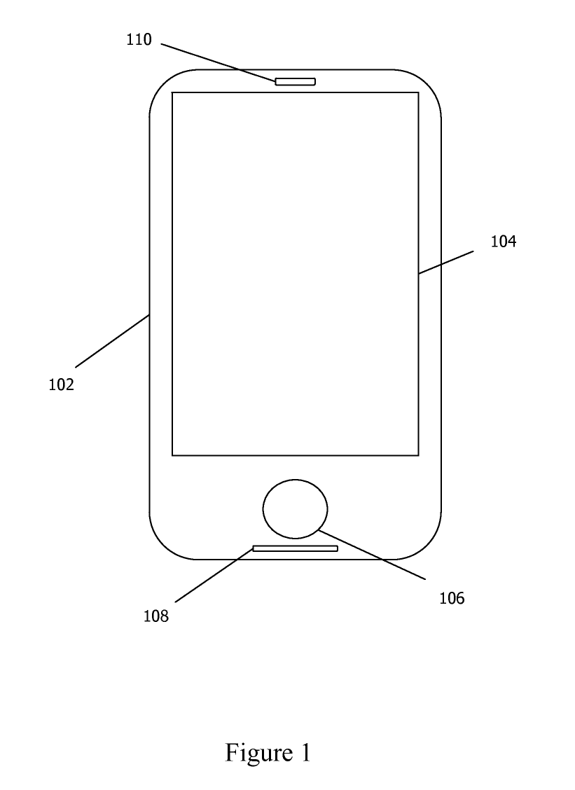

In a first embodiment, a portable device as shown in FIG. 1, has a housing 102, fingerprint sensor 106 and processing system capable of detecting and authorizing a fingerprint on the sensor. When the sensor detects the presence of touch and captures a fingerprint, it notifies a processor which executes machine-executable code to perform one or more predetermined actions in response to the detection, detecting at least one of which of several authorized fingerprints is detected and the orientation of the fingerprint detection. Machine-executable code then performs said predetermined actions based on at least one of which fingerprint was detected, and the orientation of a fingerprint detected. The fingerprint sensor may be a portion of the touch screen 104.

In a second embodiment, a portable device has a fingerprint sensor 102 and a processing system capable of detecting a fingerprint on a sensor. It also has a touch screen display 104 and graphical user interface which allows the user configure a response to a variety of inputs to the processing system. When the sensor detects the presence of touch and captures a fingerprint, it notifies a processor which executes machine-executable code to perform one or more of the user defined predetermined actions in response to the detection, depending at least one of which of several authorized fingerprints is detected. Machine-executable code then performs said predetermined actions based on which fingerprint was detected.

In a third embodiment, a portable device has a fingerprint sensor 102 and a processing system capable of detecting a fingerprint on a sensor. It has a display 104 which may incorporate said fingerprint sensor, and a graphical user interface which allows the user configure a response to a variety of inputs to the processing system. When the sensor detects the presence of touch and captures a fingerprint, it notifies a processor which executes machine-executable code to perform one or more of the user defined predetermined actions in response to the detection, depending on the orientation of a fingerprint detection. Machine-executable code then performs said predetermined actions based on at least the orientation of the fingerprint that was detected.

In a fourth embodiment a portable device which comprises a processor 508; a display 506; a memory coupled to the processor 514, the memory having instructions stored therein; and a fingerprint sensor 502, wherein the processor is configured to validate fingerprints of one or more users, and wherein the processor executes instructions from the memory to perform one or more predetermined actions in response to the detection of the fingerprint, including detecting at least one of which fingerprint was validated, and the orientation of a fingerprint, and performing a predetermined operation which depends at least one of which fingerprint was validated, and the orientation of a fingerprint.

In a fifth embodiment a portable device which comprises a processor 508; a display 506; a memory coupled to the processor 514, the memory having instructions stored therein; a global positioning system module 518; and a fingerprint sensor 502, wherein the processor is configured to validate fingerprints of one or more fingers of one or more users. It also has a user interface which allows the user configure a response to a variety of inputs to the processing system. The processor executes instructions from the memory to perform one or more predetermined actions in response to the detection of the fingerprint, including detecting at least one of which fingerprint was validated, and the orientation of a fingerprint, and performing the user determined operation which depends at least one of which fingerprint was validated, and the orientation of a fingerprint, and the location of the device.

In a sixth embodiment a cell phone which comprises a processor 508; a display 506; a camera 504; a memory coupled to the processor 514, the memory having instructions stored therein; and a fingerprint sensor, wherein the processor is configured to validate fingerprints of one or more fingers of one or more users. It also has a user interface which allows the user configure a response to a variety of inputs to the processing system. The processor executes instructions from the memory to perform one or more predetermined actions in response to the detection of the fingerprint, including detecting at least one of which fingerprint was validated, and the orientation of a fingerprint, and performing the user determined operation which depends at least one of which fingerprint was validated, and the orientation of a fingerprint.

In a seventh embodiment a cell phone which comprises a processor; a display; a camera 202; a memory coupled to the processor, the memory having instructions stored therein; incorporates a fingerprint sensor function, wherein the processor is configured to validate fingerprints of one or more fingers of one or more users. It also has a user interface which allows the user configure a response to a variety of inputs to the processing system. The processor executes instructions from the memory to perform one or more predetermined actions in response to the detection of the fingerprint. When the processor determines that the device is in a locked state, and it authenticates a fingerprint, and it determines that the phone was unlocked using an index finger of person A 302, it unlocks with the home page of person A. If the devices was unlocked with the thumb of person A at a 90 degree angle 402 (in a natural position to take a photograph), the phone goes into a camera application. If unlocked with the ring finger of person A, it goes into an emergency mode where it captures the ambient sound with a microphone 510, and sends location information to a recipient. If unlocked with the index finger of person B, it unlocks the phone to the account of person B, and shows their home page.

In an eighth embodiment a cell phone which comprises a processor; a display; a camera 202; a microphone 108; a speaker 110; a memory coupled to the processor, the memory having instructions stored therein; and a fingerprint sensor, wherein the processor is configured to validate fingerprints of one or more fingers of one or more users. It also has a user interface which allows the user configure a response to a variety of inputs to the processing system. For example, when the user starts a configuration utility, he is presented with a selection of different applications that can be started by a finger impression. After the selection is made, the user is asked if a specific orientation is to be required. The user is then asked to present the desired finger, in the desired orientation on the fingerprint sensor. When asked, the user may accept the paired fingerprint impression, and the action to be taken. The processor executes instructions from the memory to perform one or more of the user defined predetermined actions in response to the detection of the fingerprint. When the processor determines that the device is in a locked state, and it authenticates a fingerprint, and it determines that the phone was unlocked using an index finger of person A 302, it unlocks with the home page of person A. If the devices was unlocked with the right hand little finger of person A, the phone starts a requested application.

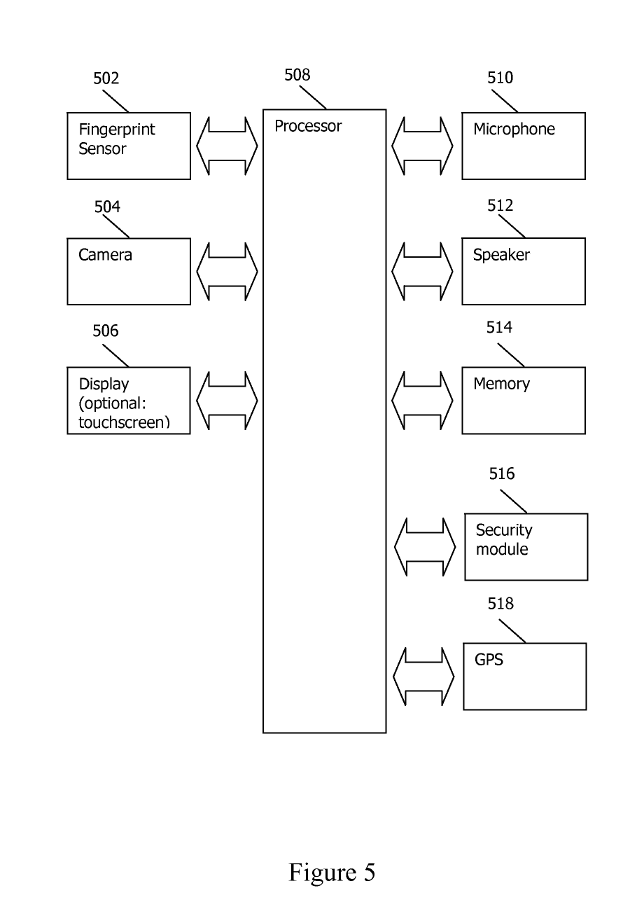

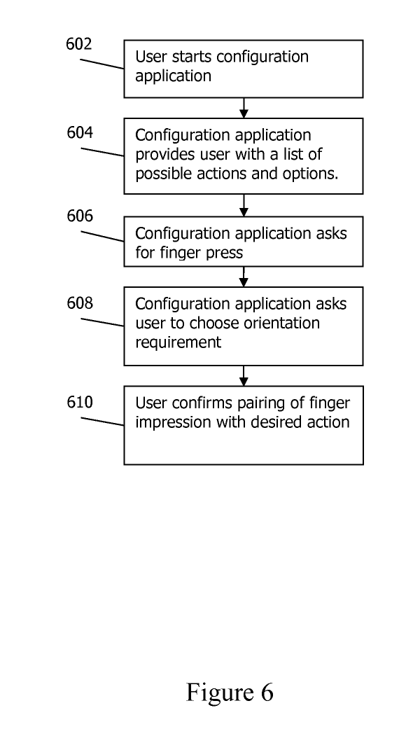

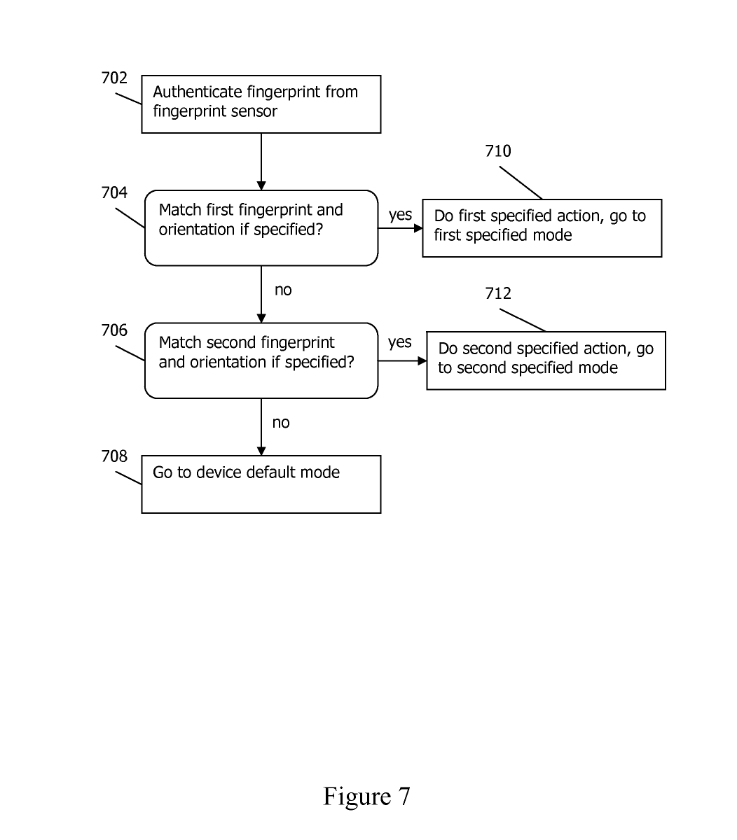

In an example of the use of an embodiment of the present invention, referring to FIG. 5, a cell phone which comprises a processor 508; a display 506; a camera 504; a microphone 508; a speaker 508; a memory coupled to the processor 514, the memory having instructions stored therein; and a fingerprint sensor 502, wherein the processor is configured to validate fingerprints of one or more fingers of one or more users. It also has a user interface which allows the user configure a response to a variety of inputs to the processing system. For example, referring to FIG. 6, when the user starts a configuration utility, he is presented with a selection of different applications that can be started by a finger impression. The user then selects to start a sound recording application. The user is asked if he wants to start recording sound when the fingerprint is registered, to which the answer is affirmative. The user is asked if a specific orientation is to be required. The user declines to require a specific orientation. The user is then asked to present the desired finger, and the user presses his right hand little finger to the fingerprint sensor. When asked, the user accepts the paired fingerprint impression, and the action to be taken. Referring to FIG. 7, the processor executes instructions from the memory to perform one or more of the user defined predetermined actions in response to the detection of the fingerprint. When the processor determines that the device is in a locked state, and it authenticates a fingerprint, and it determines that the phone was unlocked using an index finger of person A 302, it unlocks with the home page of person A. If the devices was unlocked with the right hand little finger of person A, the phone starts a sound recording application, and starts recording sound from the microphone108.

In a ninth embodiment of the invention, a portable device has a fingerprint sensor and at least two modes of operation. If the fingerprint sensor detects a first fingerprint, it goes into a mode of operation where an emergency signal is sent by means of a radio transmitter. In a second mode of operation, the device does not send out an emergency signal, but provides another function to the user of the device, for example, it allows the user to place a telephone call to a selected party.

In a tenth embodiment of the invention a system comprises a fingerprint sensor and a user interface. When the fingerprint sensor detects a first fingerprint pattern, an emergency signal is sent. For example, a preselected phone number may be dialed to a medical answering service or security service. When the fingerprint sensor detects a second fingerprint pattern a user interface is activated. For example, in this mode where a user interface is activated, the device may allow a selection of phone calls to be made from a list. When the fingerprint sensor detects an unknown fingerprint pattern, the user interface is limited, for example only 911 calls may be allowed.

In an eleventh embodiment, as depicted in FIG. 7, the machine code of the processor in a device executes the following procedures:
Authenticate fingerprint from fingerprint sensor 702
Match first fingerprint and orientation if specified? 704
If so, do first specified action, go to first specified mode 710
Match second fingerprint and orientation if specified? 706
If so, do second specified action, go to second specified mode 712
Otherwise, go to device default mode 708

After an event occurs where a fingerprint is detected by the fingerprint sensor and processed by the processor, the machine code of the device executes the following procedure:
Authenticate fingerprint from fingerprint sensor. 802
Does the pattern match first fingerprint and orientation if specified? 804
If so, do the first specified action and or enter the first specified mode. 810
If not, does the pattern match the second fingerprint and orientation, if specified? 806
If so, do the second specified action and or enter the second specified mode. 812
Otherwise, go to the device default mode. 808

Further fingerprint presentations and oriented, and actions sequenced, adding to the configuration and action sequences as discussed above, three or more finger presses resulting in additional actions by the device. The use of the term fingerprint includes thumbprints. The fingerprint sensor may or may not distinguish fingerprints from other patterns. Other biometric sensors may be substituted for authentication, the further events from the fingerprint may be reduced to recognition of which finger is being used. Once initial actions such as taking a picture have been triggered, further use of the camera may use other triggering modes such as a button or the touch screen. The fingerprint sensor may a function of the touch screen display.

In a twelfth embodiment of the invention a system comprises a fingerprint sensor and a user interface. When the fingerprint sensor detects a first fingerprint pattern, the system goes into a normal mode. For example, in this mode a user interface is activated, the device may allow phone calls to be made and photographs to be taken. When the fingerprint sensor detects a second fingerprint pattern, the system goes into a higher security mode. Optionally, the system may require a third fingerprint impression to enter the high security mode. For example, in this mode a user interface is activated, the device may allow access to banking functions. When the fingerprint sensor detects an unknown fingerprint pattern, the user interface is limited, for example only 911 calls may be allowed.

In a thirteenth embodiment, a device as shown in FIG. 5, has a fingerprint sensor 502, a security module 516, and processing system 508 capable of detecting and authorizing a fingerprint on the sensor 502. When the sensor detects the presence of touch and captures a fingerprint, it notifies a processor which executes machine-executable code to perform one or more predetermined actions in response to the detection, detecting at least one of which of several authorized fingerprints is detected and the orientation of the fingerprint detection. Machine-executable code then performs said actions based on at least one of which fingerprint was detected, and the orientation of a fingerprint detected. Machine-executable code performs the action of entering a specified security profile after detection of an authorized fingerprint impression, and machine-executable code performs the action of authorizing a higher security mode or different security functions after detection of a sequence of one or more specified fingerprint impressions. A fingerprint impression may include an orientation specification or restriction, for example a fingerprint impression registered with the right index finger of person A with the finger oriented such that it is pointing toward the top of the device may trigger a function alpha, where touching the sensor with the index finger pointed with an orientation to the right when facing the device may trigger a function beta. Triggers alpha and beta may be treated as different fingerprint impressions.

The foregoing invention has been described in some detail by way of illustration and example, for purposes of clarity of understanding, it will be obvious that certain changes and modifications may be practiced within the scope of the appended claims.

The above description is illustrative and not restrictive. Many variations of the invention will become apparent to those of skill in the art upon review of this disclosure. Merely by way of example the invention may used to configure a cell phone to activate a camera mode if unlocked with a thumb 402, and to come up in a home page mode if unlocked with an index finger 302. The scope of the invention should, therefore, be determined not with reference to the above description, but instead should be determined with reference to the appended claims along with their full scope of equivalents.

What is claimed is:

1. A method, comprising: detecting a fingerprint on a sensor of a portable device; executing machine-executable code to perform one or more predetermined actions in response to the detection, detecting at least one of which of several authorized fingerprints is detected and the orientation of a fingerprint detection, and performing said predetermined actions based on at least one of which fingerprint was detected, and the orientation of a fingerprint detected.

2. The method of claim 1, where the said predetermined actions are user configurable.

3. The method of claim 1, wherein the portable device is a smart phone.

4. The method of claim 1, wherein said portable device comprises a security module. Machine-executable code performs the action of entering a specified security profile after detection of an authorized fingerprint impression, and machine-executable code performs the action of authorizing different security functions after detection of a different fingerprint impression.

5. The method of claim 1, wherein said portable device comprises a security module. Machine-executable code performs the action of entering a specified security profile after detection of an authorized fingerprint impression, and machine-executable code performs the action of authorizing different security functions after detection of a specified fingerprint impression and one or more additional specified fingerprint impressions.

6. A portable device, comprising: a processor; a display; a memory coupled to the processor, the memory having instructions stored therein; and a fingerprint sensor, wherein the processor is configured to validate a fingerprint of one or more users, and wherein the processor executes instructions from the memory to perform one or more predetermined actions in response to the detection of the fingerprint, including detecting at least one of which fingerprint was validated, and the orientation of a fingerprint, and performing a predetermined operation which depends at least one of which fingerprint was validated, and the orientation of a fingerprint.

7. The portable device of claim 6, where the said predetermined actions are user configurable.

8. The portable device of claim 6, wherein said portable device comprises at least one of a communication device and a camera.

9. The portable device of claim 6, wherein the predetermined action of one of the fingerprint impressions is to enter a higher or different security mode.

10. The portable device of claim 6, wherein the predetermined action of one of the fingerprint impressions is to enter a mode where, upon authentication of an additional fingerprint impression, the device enters a higher or different security mode.

11. The portable device of claim 6, wherein said portable device comprises a cellular phone and a camera, wherein the processor is configured to enter a home page mode in response to detection of the index finger fingerprint of a user, and to enter a camera mode in response to detection of the thumb of a user.

12. The portable device of claim 6, wherein said portable device comprises a cellular phone and a camera, wherein the processor is configured to enter a home page mode in response to detection of the index finger at one orientation, and to enter a camera mode in response to detection of the index finger at a different orientation.

13. The portable device of claim 6, wherein said portable device comprises a security processor, wherein the processor is configured to enter a home page mode in response to detection of on one authorized fingerprint impression, and to enter a mode with different security functions in response to detection of a different finger.

14. The portable device of claim 6, wherein said portable device comprises a security processor, wherein the processor is configured to enter a mode with limited secure function access in response to detection of on one authorized fingerprint impression, and to enter a mode with different security functions in response to detection of a specified sequence of one or more fingerprint impressions.

15. An apparatus, comprising: means for detecting fingerprints; means for authenticating a fingerprint; and means for executing machine-executable code to perform one or more predetermined actions in response to the detection of a fingerprint, means for performing predetermined actions depending on which of several authorized fingerprints was detected or the orientation of a fingerprint detected.

16. The apparatus of claim 15, including means for detecting whether the fingerprint is at an orientation within a range of an orientation specified by a user, and means for performing a predetermined operation based on the orientation of the fingerprint.

17. The apparatus of claim 15, where the said predetermined actions are user configurable.

18. A system, comprising a fingerprint sensor and a user interface. When the fingerprint sensor detects a first fingerprint pattern, an emergency signal is sent.

19. The system of claim 18, where when the fingerprint sensor detects a second fingerprint pattern a user interface is activated, and where when the fingerprint sensor detects an unknown fingerprint pattern, the user interface is limited.

20. The system of claim 18, where the said second fingerprint sensor fingerprint detection is limited to a fingerprint pattern angle specified by the user, within a specified range.
